(19) United States
(12) Patent Application Publication
(10) Pub. No.: US 2024/0272448 A1
(43) Pub. Date: Aug. 15, 2024

(54) OPTICAL IMAGING DEVICES INCORPORATING A METALENS TO FACILITATE ZOOMING OPERATIONS

(71) Applicant: NIL Technology ApS, Kongens Lyngby (DK)

(72) Inventors: Ulrich Quaade, Bagsvaerd (DK); Fredrik Mattinson, Täby (SE); Villads Egede Johansen, Copenhagen (DK)

(21) Appl. No.: 18/570,290

(22) PCT Filed: Jun. 8, 2022
(86) PCT No.: PCT/EP2022/065597

§ 371 Date: Dec. 14, 2023

Related U.S. Application Data
(60) Provisional application No. 63/210,858, filed on Jun. 15, 2021.

(51) Int. Cl. G02B 27/42; G02B 1/00; G02B 5/18; G02B 15/14; G02B 23/24; H04N 23/69

(52) U.S. Cl. CPC G02B 27/4205; G02B 1/002; G02B 5/1842; G02B 15/14; H04N 23/69; G02B 23/2438; G02B 23/2484

(57) ABSTRACT

An apparatus includes a metalens, an image sensor, and an actuator. The metalens is configured to generate multiple diffractive orders of an image at respective corresponding focal lengths. The actuator operable to move at least one of the metalens or the image sensor to each of a various positions so that a distance between the metalens and the image sensor is adjusted, wherein the distance between the metalens and the image sensor for each respective one of the positions corresponds to a particular one of the focal lengths. Adjusting the distance between the metalens and the image sensor provides a zoom in or zoom out operation.

### FIELD OF THE DISCLOSURE

The present disclosure relates to optical imaging devices that incorporate a metalens to facilitate zooming operations.

### BACKGROUND

Various types of optical imaging devices such as cameras or projectors incorporate a zoom lens, that is, a lens allowing the focal length of the imaging device to be varied. Thus, a zoom lens can offer multiple focal lengths from which a photographer, for example, can select. A zoom lens may be adjusted, for example, by a user to create focused images throughout a range of distances, e.g., from close up to far away. That is, the zoom function can be used to change the apparent closeness of the image subject by increasing the focal length. To zoom in, for example, the lens moves away from the image sensor, and the scene is magnified.

### SUMMARY

The present disclosure describes optical imaging devices that incorporate a metalens to facilitate zooming operations.

For example, in one aspect, the present disclosure describes optical imaging devices that include a metalens, an image sensor, and an actuator. The metalens is configured to generate multiple diffractive orders of an image at respective corresponding focal lengths. The actuator is operable to move at least one of the metalens or the image sensor to any one of a discrete number of different positions so that a distance between the metalens and the image sensor is adjustable. The distance between the metalens and the image sensor for each respective one of the positions corresponds to a particular one of the focal lengths. Adjusting the distance between the metalens and the image sensor allows the optical imaging device to zoom in or zoom out, thereby magnifying or reducing the size of objects appearing in an image captured by the image sensor.

Some implementations include one or more of the following features. For example, in some instances there are at least three different positions for the image sensor or the metalens.

In some implementations, the image sensor is a component of a camera or an endoscopic imaging system.

The present disclosure also describes a method that includes acquiring, by an image sensor, a first image while a first distance separates the image sensor from a metalens. The method further includes moving at least one of the image sensor or the metalens such that a second distance separates the image sensor from the metalens, and acquiring, by the image sensor, a second image while the second distance separates the image sensor from the metalens. Each of the first and second images corresponds, respectively, to a different one of multiple diffractive orders of an image generated by the metalens, and moving at least one of the image sensor or the metalens provides a zoom in or zoom out operation.

Some implementations, include one or more of the following features. For example, in some instances, moving at least one of the image sensor or the metalens provides a zoom in or zoom out operation.

In some implementations, the method further includes moving again at least one of the image sensor or the metalens such that a third distance separates the image sensor from the metalens, and acquiring, by the image sensor, a third image while the third distance separates the image sensor from the metalens. The third image corresponds to a different one of the diffractive orders of the image generated by the metalens, and moving again at least one of the image sensor or the metalens provides another zoom in or zoom out operation.

In some implementations, a high-performance zoom lens system can be achieved that helps reduce the size (e.g., the z-height or footprint) of the optical imaging device.

Other aspects, features and advantages will be readily apparent from the following detailed description, the accompanying drawings and the claims.

### BRIEF DESCRIPTION OF THE DRAWINGS

FIG. 1 illustrates an example of an optical imaging device.

FIG. 2 illustrates an example of an optical imaging device in which the image sensor can be moved between at least three positions.

FIG. 3 is a flow chart illustrating an example of a method of using the optical imaging devices.

### DETAILED DESCRIPTION

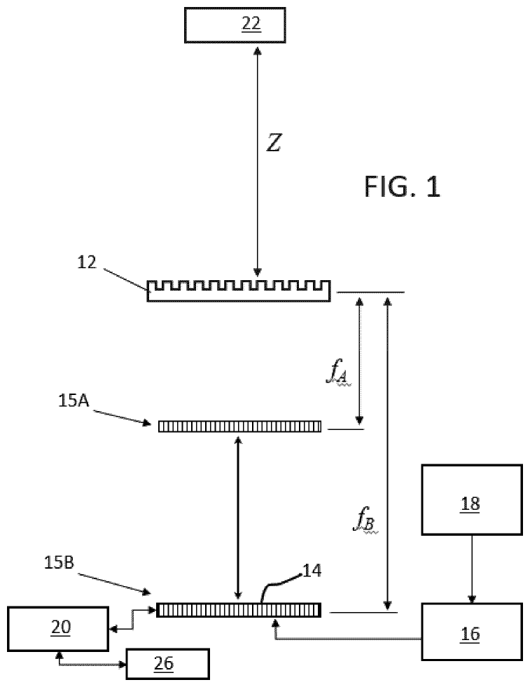

As illustrated in FIG. 1, an optical imaging device 10 include an optical metalens 12 configured to generate multiple diffractive orders of an image at different corresponding focal lengths f_{A}, f_{B} where an image sensor 14 (e.g., a CMOS sensor) can be positioned. For example, in the illustrated example, the second focal length f_{B} corresponds to the first diffractive order, and the first focal length f_{A} corresponds to the second diffractive order.

A metalens can include, for example, a metasurface, which refers to a surface with distributed small structures (e.g., meta-atoms or other nano-structures) arranged to interact with light in a particular manner. In the case of a metalens, the meta-atoms are arranged so that the metastructure functions as a lens. Metalenses tend to exhibit low-f numbers. Consequently, they can permit a large amount of light to be focused onto the sensor 14, which can facilitate relatively rapid image exposures in some implementations.

The device 10 further includes at least one actuator 16 to move one, or both, of the metalens 12 or the image sensor 14 so that the distance between the metalens and the image sensor can be adjusted.

As shown in the example of FIG. 1, the actuator 16 is operable to move the image sensor 14 between a discrete number of positions, each of which corresponds to a different respective diffractive order of the metalens 12. In particular, the actuator 16 can move the image sensor between a first position 15A corresponding to the first focal length f_{A} and a second position 15B corresponding to the second focal length f_{B}. This feature allows the device to zoom in or zoom out. For example, in some instances, the image sensor 14 may start in the first position 15A and then move to the second position 15B so as to provide a zoom out function in which an object in the device's field of view (FOV) appears smaller. In other instances, the image sensor 14 may start in the second position 15B and then move to the first position 15A so as to provide a zoom in function in which an object in the device's FOV appears larger (i.e., the image of the object is magnified).

In some implementations, instead of (or in addition to) moving the image sensor 14, the actuator 16 may cause the metalens 12 to move between different positions such that at a first position, the distance to the image sensor corresponds to the first focal length f_{A}, and at a second position, the distance to the image sensor corresponds to the second focal length f_{B}. Thus, in some implementations, there are one or more actuators 16 for causing relative movement between the metalens 12 and the image sensor 14.

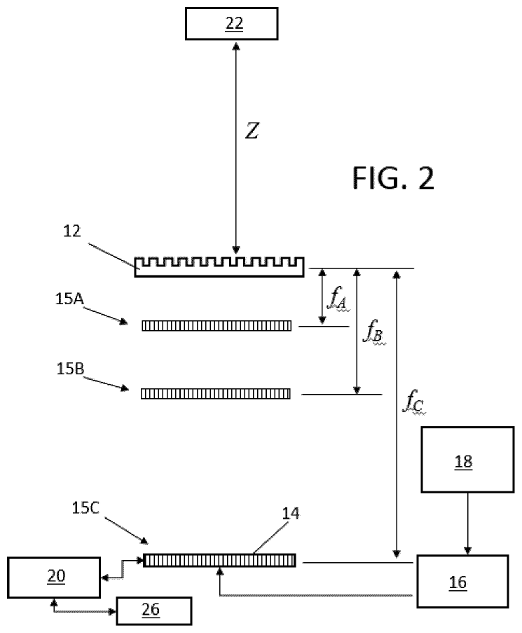

Although the illustrated example of FIG. 1 shows two different positions 15A, 15B for the image sensor 14, in some implementations there may be additional positions for the image sensor, each of which corresponds to a respective focal length for a different diffractive order of the metalens 12. FIG. 2 illustrates such an example, which shows three positions 15A, 15B, 15C for the image sensor 14, where the first position 15A is at a first focal length f_{A} corresponding to the third diffractive order of the metalens 12, the second position 15B is at a second focal length f_{B} corresponding to the second diffractive order of the metalens 12, and the third position 15C is at a third focal length f_{B} corresponding to the first diffractive order of the metalens 12. As described above, an actuator 16 can be used to move the image sensor 14 so as to adjust the distance between the metalens and the image sensor. Thus, the actuator is operable to move image sensor to any one of a number of different positions so that a discrete number of different distances (in this example, three) between the metalens and the image sensor can be obtained.

As in the example of FIG. 1, changing the position of the image sensor 14 in FIG. 2 allows the device to zoom in or zoom out. For example, in some instances, the image sensor 14 may start in the second position 15B and then move to the third position 15C so as to provide a zoom out function in which an object in the device's field of view (FOV) appears smaller. In other instances, the image sensor 14 may start in the second position 15B and then move to the first position 15A so as to provide a zoom in function in which an object in the device's FOV appears larger (i.e., the image of the object is magnified). The position of the image sensor 14 also can be moved from the first position 15A to the third position 15C, or vice-versa.

As noted above, in some implementations, instead of (or in addition to) moving the image sensor 14 in FIG. 2, the actuator 16 may cause the metalens 12 to move between different positions such that at a first position, the distance to the image sensor corresponds to the first focal length f_{A}, at a second position, the distance to the image sensor corresponds to the second focal length f_{B}, and at a third position, the distance to the image sensor corresponds to the third focal length fc. Thus, in some implementations, there are one or more actuators 16 for causing relative movement between the metalens 12 and the image sensor 14.

In general, the distance between the image sensor 14 and the metalens 12 is adjustable among a discrete number of options, each of corresponds to any one of four or more different focal lengths each of which corresponds to a different diffractive order of the metalens. Although the foregoing examples of FIGS. 1 and 2 illustrate, respectively, two and three options for the distance between the image sensor and metalens, in some implementations, the position of the image sensor 14 and/or metelens 12 may be adjusted such that the distance between them corresponds to any one of four or more different focal lengths each of which corresponds to a different diffractive order of the metalens.

The actuator 16 can be implemented, for example, as a MEMS, piezoelectric or voice-coil actuator. A microcontroller 18 or other control circuitry is operable to control the actuator 16 to cause movement of the image sensor 14 and/or metalens 12 to provide the zoom in and zoom out operations.

In operation, light reflected by an object 22 at a distance Z external to the device 10 can be collected by the sensor 14 to obtain an image at a particular one of the positions. Read-out and processing circuitry 20, which can include, for example, at least one processor (e.g., a microprocessor) configured to execute instructions stored in memory, can read out signals representing the captured image, process the signals, and display the image, for example, on a display screen 26.

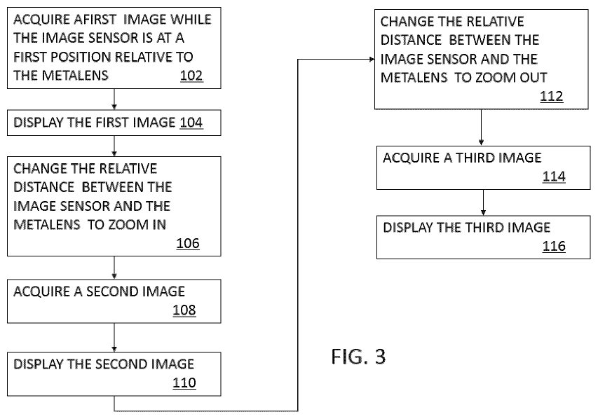

As shown, for example, in FIG. 3, a first image can be acquired while the image sensor 14 is at a first position relative to the metalens 12 (block 102), and the first image can be displayed on the display screen 26 (block 104). The relative distance between the image sensor and the metalens can be changed to provide a zoom in operation (block 106). Then a second image can be acquired (block 108) and displayed on the display screen 26 (block 110). The relative distance between the image sensor and the metalens can be changed again to provide a zoom out operation (block 112). Then a third image can be acquired (block 114) and displayed on the display screen 26 (block 116). Additional zoom in and zoom out operations can be performed, and additional images acquired and displayed.

The optical imaging device can be integrated, for example, into various types of apparatus including cameras (e.g., a digital camera, a video camera, a monitoring camera, a security camera, a vehicle-mounted camera, or a telephone camera) or optical projectors. In some instances, the imaging device can be incorporated into, or externally provided to, a personal or desktop computer, a portable digital device (e.g., a smart phone or other mobile phone), a wearable device, a laptop computer, a tablet terminal, or a mobile computer, their peripheral devices (such as a scanner, a printer, or a mouse), or other digital apparatuses (such as a drive recorder).

The imaging device also can be used, for example, in high-magnification endoscopic imaging systems. The ability to magnify endoscopic images in real-time can permit visualization of mucosal details that might otherwise not be seen.

Various aspects of the subject matter and the functional operations described in this specification (e.g., the microprocessor 18 and/or processing circuitry 20) can be implemented in digital electronic circuitry, or in computer software, firmware, or hardware, or in combinations of one or more of them. Thus, aspects of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The apparatus can include, in addition to hardware, code that creates an execution environment for the computer program in question, e.g., code that constitutes processor firmware.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Features described in connection with different implementations can, in some instances, be combined in the same implementation. Further, various other modifications can be made to the foregoing examples. Thus, other implementations also are within the scope of the claims.

1. An apparatus comprising:
a metalens configured to generate a plurality of diffractive orders of an image at respective corresponding focal lengths;
an image sensor; and
an actuator operable to move at least one of the metalens or the image sensor to each of a plurality of positions so that a distance between the metalens and the image sensor is adjusted, wherein the distance between the metalens and the image sensor for each respective one of the positions corresponds to a particular one of the focal lengths, and wherein adjusting the distance between the metalens and the image sensor provides a zoom in or zoom out operation.

2. The apparatus of claim 1 wherein the actuator is operable to move the image sensor to each of the plurality of positions.

3. The apparatus of claim 1 wherein the actuator is operable to move the metalens to each of the plurality of positions.

4. The apparatus of claim 1 wherein the plurality of positions includes at least three different positions.

5. The apparatus of claim 1 wherein the image sensor is a component of a camera.

6. The apparatus of claim 1 wherein the image sensor is a component of an endoscopic imaging system.

7. A method comprising:
acquiring, by an image sensor, a first image while a first distance separates the image sensor from a metalens;
moving at least one of the image sensor or the metalens such that a second distance separates the image sensor from the metalens; and
acquiring, by the image sensor, a second image while the second distance separates the image sensor from the metalens;
wherein each of the first and second images corresponds, respectively, to a different one of a plurality of diffractive orders of an image generated by the metalens, and wherein moving at least one of the image sensor or the metalens provides a zoom in or zoom out operation.

8. The method of claim 7 wherein moving at least one of the image sensor or the metalens includes moving the image sensor.

9. The method of claim 7 wherein moving at least one of the image sensor or the metalens includes moving the metalens.

10. The method of claim 7 wherein moving at least one of the image sensor or the metalens provides a zoom in operation.

11. The method of claim 7 wherein moving at least one of the image sensor or the metalens provides a zoom out operation.

12. The method of claim 7 further including:
moving again at least one of the image sensor or the metalens such that a third distance separates the image sensor from the metalens; and
acquiring, by the image sensor, a third image while the third distance separates the image sensor from the metalens;
wherein the third image corresponds to a different one of the plurality of diffractive orders of the image generated by the metalens, and wherein moving again at least one of the image sensor or the metalens provides another zoom in or zoom out operation.

13. The apparatus of claim 2 wherein the plurality of positions includes at least three different positions.

14. The apparatus of claim 13 wherein the image sensor is a component of a camera.

15. The apparatus of claim 3 wherein the plurality of positions includes at least three different positions.

16. The apparatus of claim 15 wherein the image sensor is a component of a camera.

17. The method of claim 8 further including:
moving again at least one of the image sensor or the metalens such that a third distance separates the image sensor from the metalens; and
acquiring, by the image sensor, a third image while the third distance separates the image sensor from the metalens;
wherein the third image corresponds to a different one of the plurality of diffractive orders of the image generated by the metalens, and wherein moving again at least one of the image sensor or the metalens provides another zoom in or zoom out operation.

18. The method of claim 9 further including:
moving again at least one of the image sensor or the metalens such that a third distance separates the image sensor from the metalens; and
acquiring, by the image sensor, a third image while the third distance separates the image sensor from the metalens;
wherein the third image corresponds to a different one of the plurality of diffractive orders of the image generated by the metalens, and wherein moving again at least one of the image sensor or the metalens provides another zoom in or zoom out operation.

19. The method of claim 10 further including:
moving again at least one of the image sensor or the metalens such that a third distance separates the image sensor from the metalens; and
acquiring, by the image sensor, a third image while the third distance separates the image sensor from the metalens;
wherein the third image corresponds to a different one of the plurality of diffractive orders of the image generated by the metalens, and wherein moving again at least one of the image sensor or the metalens provides another zoom in or zoom out operation.

20. The method of claim 11 further including:
moving again at least one of the image sensor or the metalens such that a third distance separates the image sensor from the metalens; and
acquiring, by the image sensor, a third image while the third distance separates the image sensor from the metalens;
wherein the third image corresponds to a different one of the plurality of diffractive orders of the image generated by the metalens, and wherein moving again at least one of the image sensor or the metalens provides another zoom in or zoom out operation.
